(19) United States
(12) Patent Application Publication
(10) Pub. No.: US 2007/0254678 A1
(43) Pub. Date: Nov. 1, 2007

(54) Devices and methods for ringback control

(76) Inventors: Gregory R. Black, Vernon Hills, IL (US); Charles P. Binzel, Bristol, WI (US)

Correspondence Address: MOTOROLA INC, 600 NORTH US HIGHWAY 45, ROOM AS437, LIBERTYVILLE, IL, 60048-5343, US

(21) Appl. No.: 11/415,339

(22) Filed: May 1, 2006

(51) Int. Cl. H04Q 7/20

(52) U.S. Cl. 455/458

(57) ABSTRACT

Disclosed is a wireless communication device and method for ringback control, the device capable of receiving an incoming call, the device having a timing circuit configured to determine a delay for a predetermined period of time for ringtone generation at a calling party device. A device with a single transducer may increase the volume of a ringtone or other alerts. The delay may correspond to the increased volume. In one embodiment, the delay of the ringtone generation at the calling party is provided by delaying the transmission of the acknowledgment alerting signal by the wireless communication device until after the predetermined period of the delay. In another embodiment, the alerting signal includes a delay parameter so that the wireless infrastructure delays signaling a ringtone to the calling party device. In another embodiment, the alerting signal includes a delay parameter so that the calling party device delays the activation of a ringtone.

### FIELD

Disclosed are a wireless communication device and method for ringback control, and more particularly a device capable of receiving an incoming call, the device having a timing circuit configured to determine a delay for a predetermined period of time for ringtone generation at a calling party device.

### BACKGROUND

In developing markets, demand for low cost or low tier wireless communication devices continues to grow. One aspect of satisfying the demand for devices is by making the devices more affordable. Low costs for manufacturing low tier wireless communication devices are maintained, in part, by limiting the number of components of the device. Use of a single output transducer for generating the sounds of the device may help maintain a lower cost in the manufacture of a low tier wireless communication device. The single transducer may generate sounds including a ringtone, alerts such as a low battery alert, as well as voice or audio communication output such as earpiece and speaker phone outputs.

In a device with a single output transducer, the transducer is positioned as an earpiece. Because a telephone may ring loudly, safety is a concern when the earpiece is adjacent to a user's ear. To avoid loud and potentially ear damaging sounds generated by the earpiece transducer, manufacturers can cause the transducer to incrementally increase sounds from soft to loud over a period of time. The ramp up of the transducer's sound can give the user an opportunity to pull the earpiece away from his/her ear before the transducer's sound becomes too loud.

The initial sound of a ramped up incoming call ringtone may be too low to be heard by the user when the earpiece is not adjacent to the user's ear. Accordingly, the call receiving party may not respond quickly to the incoming call ringtone due to the ramp up feature. A calling party, on the other hand, almost immediately receives an acknowledgment alert signal that the incoming call paging request signal has been received. Since the ringing may be generated by the wireless network infrastructure or the calling device itself upon receipt of the acknowledgment alert signal, it may seem to the calling party that the user of the call receiving device does not answer the incoming call. Accordingly, the calling party may terminate the call prematurely or hang up before the call receiving party answers the call. It would be beneficial if the acknowledgement alert signal sent to the calling party device were controlled so that ringing heard by the calling party at the calling party device can start later than the onset of the ramped up incoming call ringtone.

### BRIEF DESCRIPTION OF THE DRAWINGS

FIG. 1 shows a wireless communication device of an incoming call receiving device, a remote server of a wireless infrastructure and a calling party device;

FIG. 2 is a flow chart of an embodiment of a method of an incoming call receiving device;

FIG. 3 is a signal flow diagram illustrating a delay determination and alert signal transmission embodiment;

FIG. 4 is a signal flow diagram illustrating a delay determination and alert signal transmission embodiment; and

FIG. 5 is a signal flow diagram illustrating a delay determination and alert signal transmission embodiment.

### DETAILED DESCRIPTION

Disclosed is a wireless communication device capable of receiving a call from a calling party through a wireless infrastructure and of generating ringback control. The device can include a timing circuit configured to determine a delay for a predetermined period of time for ringtone generation at the calling party. The described ringback control may be processed by the call receiving device to control the timing of the ringtone generated at the calling party device. In one embodiment, the delay of the ringtone generation at the calling party is provided by delaying the transmission of the acknowledgment alerting signal by the wireless communication device until after the predetermined period of the delay. In another embodiment, the alerting signal includes a delay parameter so that the wireless infrastructure delays signaling a ringtone to the calling party. In another embodiment, the alerting signal includes a delay parameter so that the calling party device delays the activation of a ringtone. Accordingly, the acknowledgement alert signal sent to the calling party device can be delayed so that ringing heard by the calling party at the calling party device can start later than the onset of the ramped up incoming call ringtone. In this way, the calling party may be less inclined to prematurely terminate the call.

Also disclosed is a method for ringback control processed by a wireless communication device capable of receiving a call from a calling party through a wireless infrastructure and capable of determining a delay for a predetermined period of time for ringtone generation at the calling party and transmitting an alerting signal to the wireless infrastructure. Further disclosed is modulating the sound generated by the sound transducer of the wireless communication device to incrementally escalate sound and that the delay of a predetermined period of time can correspond to incremental escalation of sound from the sound transducer.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

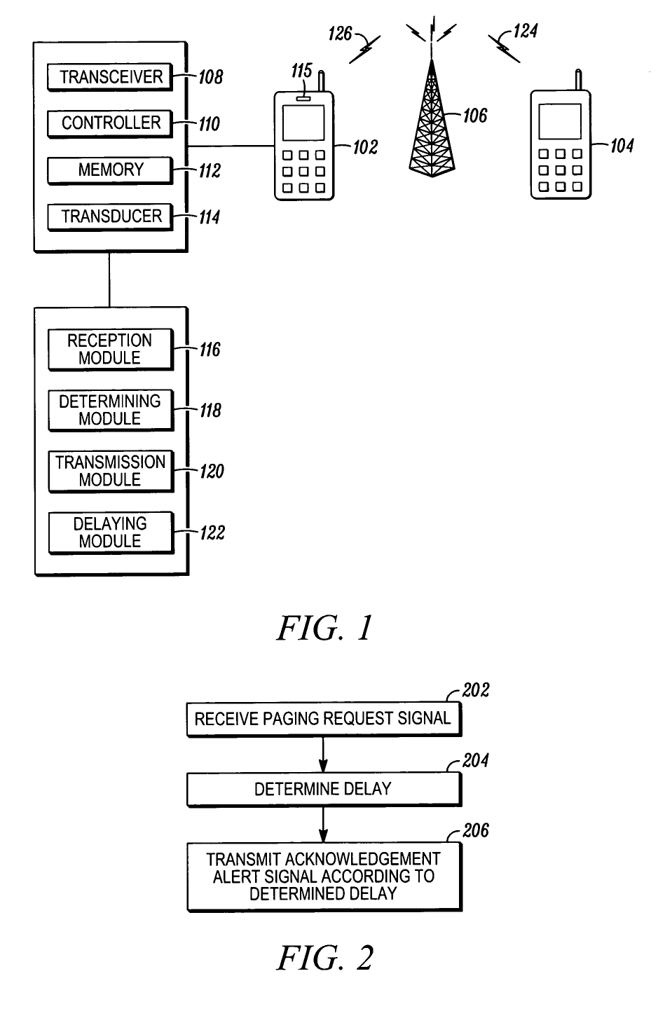

FIG. 1 shows a wireless communication device that can be an incoming call receiving device, a remote server of a wireless infrastructure and a calling party device. The incoming call receiving device 102 and the calling party device 104 may be similar. Device 102 and device 104 may communicate via wireless infrastructure 106.

The wireless communication device 102 may be implemented as a cellular telephone (also called a mobile phone). The wireless communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, PPT messaging, IMing messaging, Internet access, multi-media content access and/or voice over internet protocol (VoIP).

The remote server 106 is depicted as within a wireless infrastructure. The infrastructure of course may be any type of wireless network including an ad hoc or wireless personal area network, a WiFi or wireless local area network, and a cellular or wireless wide area network. Likewise, the server 106 may be of any suitable configuration. The server 106 may be implemented as a single server or as a plurality of servers in communication in any arrangement. The operations of the server 106 may be distributed among different servers or devices that may communicate in any manner. It is understood that the depiction in FIG. 1 is for illustrative purposes.

Referring to wireless communication device 102, it may include a transceiver 108, a controller or processor 110, memory 112 and sound transducer 114 that may be the device's single sound transducer, and may be positioned at the earpiece 115. A single output transducer may be for generating the sounds of the device including a ringtone, alerts such a low battery alert, calendar, alarm clock and message alerts, as well as voice or audio communication output. It is understood that device 102 may include more than one transducer.

Modules 116, 118, 120 and 122 may include ringback control instruction modules that are hardware or software and may be stored in memory 112. The modules can carry out certain processes of the methods as described herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The modules can include a reception module 116, a determining module 118, a transmission module 120 and a delaying module 122. The operations in accordance with the modules will be discussed in more detail below.

FIG. 1 further depicts that device 104 can transmit a signal 124 to initiate a call to wireless communication device 102 via the wireless infrastructure 106 that relays a paging request signal 126 to device 102. In return the wireless communication device 102 can transmit to the device 104 an acknowledgement alert signal by communication channels 124 and 126. The signals discussed herein may be some of the signals transmitted between the devices to establish a call between the devices. Other signals are outside the scope of this discussion. It is understood that other signals may be provided to initiate and process a communication between devices 102 and 104.

FIG. 2 is a flow chart of steps of a method for ringback control between devices 102 and 104. The call receiving device, that is, wireless communication device 102 of FIG. 1, receives a paging request signal 202 that is transmitted via the wireless infrastructure from the calling party device 104 of FIG. 1. The device 102 determines a delay 204 for a predetermined period of time for ringtone generation at the calling party's device 104. The delay may be processed in a plurality of manners as will be discussed below. As mentioned, the initial sound of a ramped up incoming call ringtone may be too low to be heard by the user of device 102 when the earpiece transducer is not adjacent to the user's ear. Accordingly, the call receiving party may not respond quickly to the incoming call ringtone due to the ramp up feature. The acknowledgement alert signal is therefore transmitted to the calling party device 104 so that the acknowledging ringtone heard by the calling party device is delayed 206. Accordingly, the ringing heard by the calling party at the calling party device can start later than the onset of the ramped up incoming call ringtone. It may therefore appear to the calling party that the call receiving device only just started to ring, even though the actual ringtone started a predetermined time before heard by the calling party. The calling party of the calling party device 104 therefore may be less inclined to hang up the call.

The ramped up incoming call ringtone may take any form. Moreover, the same or similar ramped up transducer volume may be used for other sound generated by the transducer, such as a battery alert. Certain ringtones, for example a song, may linearly increase in volume. In one embodiment, the sound may increase according to a step function, for example every one or two seconds. The first increment may be an audible sound that is sufficient to be heard when the earpiece of the call receiving device is adjacent to the user's ear. However, it may not be sufficient to be heard when the earpiece is not adjacent to the user's ear. While sound escalates, the sound of the transducer may become easier and more audible to hear when not adjacent to the user's ear. For example, the escalation of sound may take place over any predetermined length of time, such as six or ten seconds. Accordingly, the delay of a predetermined period of time can be variable.

The delay of the alerting signal may be until the sound escalates to a predefined level. In one embodiment, the modulation of sound generated by a sound transducer of the wireless communication device may incrementally escalate sound from the sound transducer. Accordingly, the delay of a predetermined period of time can correspond to incremental escalation of sound from the sound transducer. In another embodiment, the predefined level is a sound pressure level (SPL) which is an acoustic measurement for the ratios of sound energy rated in decibels (SPL dBA, SPL dBC). Accordingly, the delay of the alerting signal may correspond to an SPL. In still another embodiment, the delay of the alerting signal is until the sound escalates to a predefined percentage of a total ring tone volume. It is understood that the sound may change in volume in any manner. Furthermore, the delay may be configured to correspond to the change in sound in any manner. Since the delay with audible alerts may be based on the SPL, the delay with non-audible alerts, such as vibrating alerts, may be accordingly low.

The delay may be automatically or manually configured. The delay may be configured by the manufacturer prior to shipment. Alternatively, the delay may be preset by the user by preference. Variable delays may be determined, for example, based on caller identification. Moreover, a delay may be determined on an ad hoc basis to the call receiving device in response to a prompt to the user. On the other hand, the delay may correspond to incremental escalation of sound from the sound transducer. In this way the delay of a predetermined period of time may be between about 0.1 seconds and about ten seconds. It is understood that any manner in which to determine the delay is within the scope of this discussion.

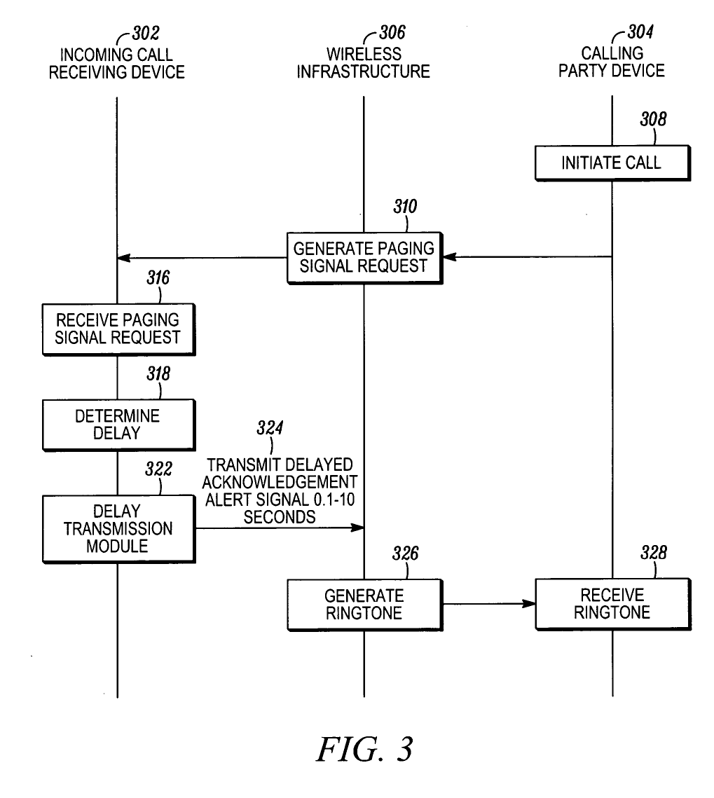

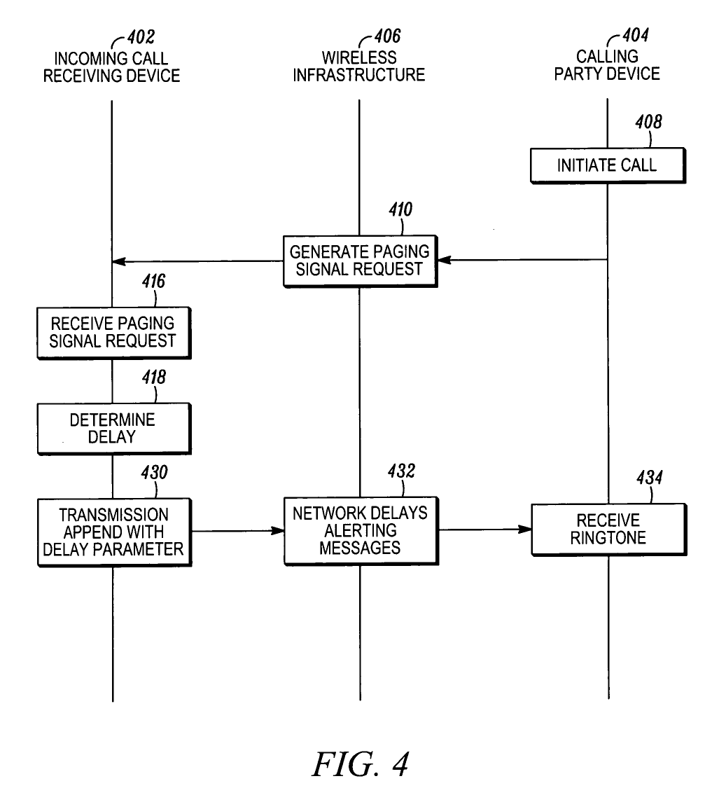

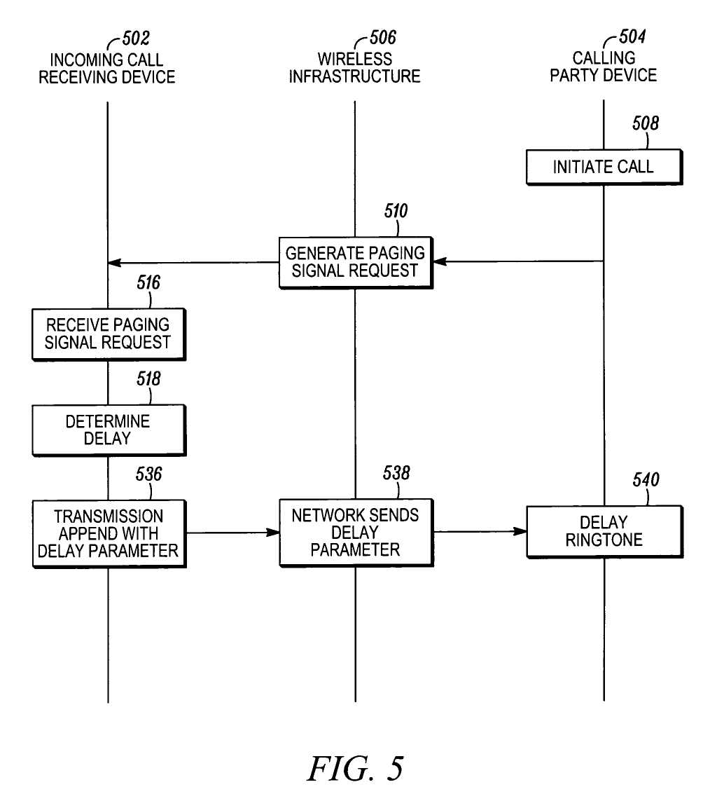

FIG. 3 is a signal flow diagram showing a delay determination embodiment for ringback control. FIGS. 4 and 5 each also show signal flow diagrams for other delay determination embodiments. It is understood that one or more of these may be combined, and others are within the scope of this discussion.

The incoming call receiving device 302 and the calling party device 304 generally transmit and receive signals via the wireless infrastructure 306. While this discussion refers to the calling party device 304 as a wireless communication device, as discussed above, it may also be any other type of device, including a wire line/land line device.

The calling party device 304 can initiate a call 308. In doing so the wireless infrastructure 306 may generate a paging signal request 310 to the incoming call receiving device 302. The transceiver (108, see FIG. 1) of the device 302 can be configured to receive the paging signal request 316 which can be processed by the device's controller (110, see FIG. 1) according to instructions of the receiving module (116, see FIG. 1). The delay can be determined 318 in a manner as discussed above and according to instructions of the determining module (118, see FIG. 1).

In one embodiment, a delaying module (122, see FIG. 1) can delay 322 the transmission of the acknowledgement alert signal. Accordingly, in one embodiment, the delay of the ringtone generation at the calling party is provided by delaying the transmission 324 of the acknowledgment alerting signal by the wireless communication device until after the predetermined period of the delay according to instructions of the transmission module (120, see FIG. 1). The acknowledgement alert signal can be received 326 by the wireless infrastructure 306 and a ringtone generated that can be received 328 by the calling party device 304. Alternatively, the acknowledgement alert signal may be relayed or passed through to the calling party device, as described below.

In the described embodiment, the acknowledgement alert signal sent to the calling party device can be delayed so that ringing heard by the calling party at the calling party device can start later than the onset of the ramped up incoming call ringtone. It may therefore appear to the calling party that the call receiving device only just started to ring, even though the actual ringtone at the call receiving device 302 started a predetermined time earlier than heard by the calling party at the calling party device 304. The calling party of the calling party device therefore may be less inclined to terminate the call.

As mentioned, FIG. 4, is a signal flow diagram showing another delay determination embodiment for ringback control. The incoming call receiving device 402 and the calling party device 404 generally transmit and receive signals via the wireless infrastructure 406. While this discussion refers to the calling party device 404 as a wireless communication device, as discussed above, it may also be any other type of device, including a wire line/land line device.

The calling party device 404 can initiate a call 408. In doing so the wireless infrastructure 406 may generate a paging signal request 410 to the incoming call receiving device 402. The transceiver (108, see FIG. 1) of the device 402 can be configured to receive the paging signal request 416 which can be processed by the device's controller (110, see FIG. 1) according to instructions of the receiving module (116, see FIG. 1). The delay can be determined 418 in a manner as discussed above and according to instructions of the determining module (118, see FIG. 1).

In this embodiment, the alerting signal includes a delay parameter so that the wireless infrastructure delays signaling a ringtone to the calling party. Accordingly, the transmission of the alert signal 430 may be appended with an additional field indicating the delay for actuating a ringing at the calling party. The appended alert signal can be processed 432 by the wireless infrastructure 406. The ringing generated by the wireless infrastructure and heard by the calling party at the calling party device 404 can start later than the onset of the ramped up incoming call ringtone of the incoming call receiving device 402. Alternatively the ringing generated by the wireless infrastructure and heard by the calling party at the calling party device 404 can be generated with ramped-up amplitude according to the indicated delay.

As mentioned, FIG. 5, is a signal flow diagram showing another delay determination embodiment for ringback control. The incoming call receiving device 502 and the calling party device 504 generally transmit and receive signals via the wireless infrastructure 506. While this discussion refers to the calling party device 504 as a wireless communication device, as discussed above, it may also be any other type of device, including a wire line/land line device.

The calling party device 504 can initiate a call 508. In doing so the wireless infrastructure 506 may generate a paging signal request 510 to the incoming call receiving device 502. The transceiver (108, see FIG. 1) of the device 502 can be configured to receive the paging signal request 516 which can be processed by the device's controller ( 110, see FIG. 1) according to instructions of the receiving module (116, see FIG. 1). The delay can be determined 518 in a manner as discussed above and according to instructions of the determining module (118, see FIG. 1).

In this embodiment, the alerting signal includes a delay parameter so that the calling party device 504 delays signaling a ringtone to the calling party. Accordingly, the transmission of the alert signal 536 may be appended with an additional field indicating the delay for actuating a ringing by the calling party device 504. The appended alert signal can be processed 538 by the wireless infrastructure 506. The ringing therefore can be generated by the calling party device 540 and heard by the calling party at the calling party device 504 according to the delay parameter of the alert signal. The calling party device 504 may therefore process the ringback control parameter. Accordingly, the ringing heard by the calling party can start later than the onset of the ramped up incoming call ringtone of the incoming call receiving device 502. Alternatively the ringing heard by the calling party can be generated with ramped-up amplitude according to the delay ringback control parameter.

The networks shown in FIGS. 3, 4 and 5 of course may be any type of wireless network including an ad hoc or wireless personal area network, a WiFi or wireless local area network, and a cellular or wireless wide area network. It is understood that the depictions in FIGS. 3, 4 and 5 are for illustrative purposes.

While FIGS. 3, 4 and 5 show a network communicating with both devices, the same or similar operations shown in those figures may take place without a network. For example, were the devices configured to operate as mobile-to-mobile connections, the methods shown in FIGS. 3, 4 and 5 may still be operable.

The described ringback control may be processed by a call receiving wireless communication device. Ringback control appended to the alert signal received by the wireless infrastructure and the calling party device may be processed as well. In a wireless communication device that incorporates ramp up transducer sound, including that of a device with one transducer, a wireless communication device having a timing circuit configured to determine a delay for a predetermined period of time for ringtone generation at the calling party, beneficially may avoid the calling party terminating a call. It is understood that any combination of the above-described embodiments is within the scope of this discussion. Furthermore, it is understood that certain wireless infrastructure adaptations may better facilitate the above-described technology.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A wireless communication device capable of receiving a call from a calling party device, the wireless communication device comprising:
a receiver configured to receive a paging request signal indicating an incoming call from the calling party device;
a timing circuit configured to determine a delay for a predetermined period of time for ringtone generation at the calling party device; and
a transmitter configured to transmit an alerting signal for signaling generation of a ringtone at the calling party device in response to receipt of the paging request signal.

2. The device of claim 1, wherein the delay for a predetermined of time comprises at least one of a delay of activation and a ramped-up amplitude.

3. The device of claim 1, wherein the timing circuit is further configured to delay transmission of the alerting signal by the device until after the predetermined period of the delay.

4. The device of claim 1, wherein the delay of a predetermined period of time is between about 0.1 seconds and about ten seconds.

5. The device of claim 1, wherein the alerting signal comprises a delay parameter so that a wireless infrastructure that receives and relays the alerting signal delays signaling a ringtone to the calling party.

6. The device of claim 1, wherein the alerting signal comprises a delay parameter so that the calling party device delays the activation of a ringtone.

7. The device of claim 1, further comprising:
a controller;
a sound transducer coupled to the controller; and
a sound modulating module coupled to the sound transducer and configured to escalate sound from the sound transducer.

8. The device of claim 7, wherein the delay of the alerting signal is until the sound escalates to a predefined level.

9. The device of claim 8, wherein the predefined level is a sound pressure level.

10. The device of claim 7, wherein the delay of the alerting signal is until the sound escalates to a predefined percentage of a total ring tone volume.

11. The device of claim 7, wherein the sound modulating module is configured to incrementally escalate sound from the transducer, and wherein the delay of a predetermined period of time corresponds to incremental escalation of sound from the sound transducer.

12. The device of claim 7, wherein the sound is a ringtone.

13. A method of a wireless communication device capable of receiving a call from a calling party device, the method comprising:
receiving a paging request signal indicating an incoming call from the calling party device;
determining a delay for a predetermined period of time for ringtone generation at the calling party device; and
transmitting an alerting signal in response to receiving the paging request signal.

14. The method of claim 13, further comprising:
delaying transmission of the alerting signal by the device until after the predetermined period of the delay.

15. The method of claim 13, further comprising:
delaying the transmission of the alerting signal for a predetermined period of time that is between about 0.1 seconds and about ten seconds.

16. The method of claim 13, wherein transmitting an alert signal further comprises:
including with the transmission of the alerting signal, a delay parameter so that a wireless infrastructure that receives the alerting signal and relays the alerting signal delays signaling a ringtone to the calling party.

17. The method of claim 13, further comprising:
including with the transmission of alerting signal, a delay parameter so that the calling party delays the activation a ringtone.

18. The method of claim 13, further comprising:
modulating the sound generated by a sound transducer of the wireless communication device to escalate sound from the sound transducer.

19. The method of claim 18, further comprising configuring the delay of a predetermined period of time to correspond to escalation of sound from the sound transducer.

20. The device of claim 19, further comprising:
delaying the alerting signal until the sound escalates to a sound pressure level.

21. The device of claim 19, further comprising:
delaying the alerting signal until the sound escalates to a predefined percentage of a total ring tone volume.

22. The device of claim 19, wherein the sound transducer is configured to incrementally escalate sound, the method further comprising:
delaying the alerting signal to correspond to incremental escalation of sound from the sound transducer.

23. A wireless communication device, comprising:
a transceiver configured to transmit and receive wireless communication signals;
a reception module coupled to the transceiver and configured to receive a paging request signal from a remote server, wherein a receipt of the paging request is to indicate to the wireless communication device an incoming call from a calling party device;
a determining module configured to determine a delay for a predetermined period of time for ringtone generation at the calling party device; and
a transmission module configured to transmit an alerting signal to the remote server to generate a ringtone to the calling party device.

24. The wireless communication device of claim 23, further comprising:
a delaying module configured to delay transmission of the alerting signal by the wireless communication device until after the predetermined period of the delay.

25. The wireless communication device of claim 23, wherein the alerting signal comprises a delay parameter so that the remote server delays signaling a ringtone to the calling party device.

26. The wireless communication device of claim 23, wherein the alerting signal comprises a delay parameter so that the calling party device delays the activation of a ringtone.

27. The wireless communication device of claim 23, wherein the delay of a predetermined period of time is between about 0.1 seconds and about ten seconds.
